(19) United States
(12) Patent Application Publication
(10) Pub. No.: US 2009/0245142 A1
(43) Pub. Date: Oct. 1, 2009

(54) ADDITIVE SERVICE BEACON

(76) Inventors: Roy Want, Los Altos, CA (US); Trevor Pering, San Francisco, CA (US); Shivani Sud, Mountain View, CA (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 12/060,009

(22) Filed: Mar. 31, 2008

(51) Int. Cl. H04L 12/16

(52) U.S. Cl. 370/259

(57) ABSTRACT

Embodiments of methods and apparatus for wirelessly transmitting a plurality of beacons describing one or more services offered by a service providing device are disclosed. In some embodiments, the service providing device transmits a first beacon including a first component providing a basic description of one or more services offered by the service providing device, and a second component providing a first part of an expanded description of the one or more services; and transmits wirelessly a second beacon including another first component re-providing the basic description of the one or more services, and another second component providing a second part of the expanded description of the one or more services. Additional variants and embodiments are also disclosed.

### TECHNICAL FIELD

Embodiments of the disclosure relate generally to wireless networking, and more particularly, to methods and apparatus for announcing services provided by service providing devices to services consuming devices.

### BACKGROUND

Mobile consumer electronic devices are developing at a rapid pace. Complex wireless networks, such as wireless local area networks (WLAN), wireless personal area networks (WPAN), wireless wide area networks (WWANs), etc., are being created by linking one or more such mobile devices, using a variety of wireless technologies, such as Institute of Electrical and Electronics Engineers (IEEE) 802.11 standards (e.g., 802.11g, released on June, 2003), including those that are Wi-Fi compatible, Bluetooth, ultra-wide band (UWB), etc. Some of these radio technologies support dynamic ad hoc peer to peer connections (e.g., ad hoc WPANs). An increase in the number of devices in a wireless network may lead to an increase in the time involved in discovering services available in the network.

### BRIEF DESCRIPTION OF THE DRAWINGS

Various embodiments will be described referencing the accompanying drawings in which like references denote similar elements, and in which:

FIG. 1 illustrates a block diagram representation of a service providing device transmitting a plurality of beacons in accordance with various embodiments;

FIG. 2 illustrates an exemplary flow diagram illustrating transmission of a plurality of beacons in accordance with various embodiments; and

FIG. 3 illustrates a block diagram representation of an example processor based system that may be used to practice various embodiments.

### DETAILED DESCRIPTION OF ILLUSTRATIVE EMBODIMENTS

Illustrative embodiments include, but are not limited to, methods and apparatus for announcing services offered by service providing devices to service consuming devices.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in some embodiments” is used repeatedly. The phrase generally does not refer to the same embodiments; however, it may. The terms “comprising,” “having,” and “including” are synonymous, unless the context dictates otherwise. The phrase “A and/or B” means (A), (B), or (A and B). The phrase “A/B” means (A), (B), or (A and B), similar to the phrase “A and/or B.” The phrase “at least one of A, B and C” means (A), (B), (C), (A and B), (A and C), (B and C) or (A, B and C). The phrase “(A) B” means (B) or (A and B), that is, A is optional.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the invention. This application is intended to cover any adaptations or variations of the embodiments discussed herein. Therefore, it is manifestly intended that the embodiments of the invention be limited only by the claims and the equivalents thereof.

While example embodiments may be described herein in relation to a general wireless network, the embodiments are not limited thereto and various embodiments can be applied to different types of wireless networks where similar advantages may be obtained. Such networks may include, but are not limited to, WLANs, WPANs, and the like.

The following embodiments may be used in a variety of applications including transmitters and receivers of a mobile wireless radio system. Radio systems specifically included within the scope of the embodiments of the present invention may include, but are not limited to, network interface cards (NICs), network adaptors, base stations, access points (APs), gateways, bridges, hubs and satellite radiotelephones. Further, the radio systems within the scope of embodiments of the invention may include satellite systems, personal communication systems (PCS), two-way radio systems, global positioning systems (GPS), two-way pagers, laptops, personal computers (PCs) and related peripherals, personal digital assistants (PDAs), MP3 players, set-top box, DVD players, digital cameras, mobile phones, personal computing accessories and all existing and future arising systems which may be related in nature and to which the principles of the embodiments could be suitably applied.

In a conventional wireless network including a plurality of wireless devices offering different types of services, a service consuming device may discover a service providing device by listening to the service providing device's Media Access Control (MAC) layer announcements. Each announcement may include very basic information about the service providing device. For example, a Bluetooth compatible service providing device may only specify a class of the service providing device in its MAC layer announcement, but this information may be extremely limited (e.g., 24 bits), and may not describe the services available. That is, this type of MAC layer announcements may help in device discovery, but not for discovering the types of services (or other associated information) provided by the discovered service providing device.

To obtain information about one or more types and/or description of services offered by the service providing device, typically under the prior art, the service consuming device may have to first establish a wireless connection with the service providing device. For example, the service consuming device may have to first discover the service providing device, obtain an internet protocol (IP) address of the service providing device, establish an IP connection with the service providing device, and then, using an appropriate technique (e.g., listen for IP layer service broadcast, probe the service providing device for service description, listen for universal plug and play (UPnP) broadcast, etc.) discover more detailed information about one or more types of services offered by the service providing device.

To merely obtain information about one or more types and/or description of services offered by the service providing device requires establishing a wireless connection with the service providing device and then negotiating assignment of an IP address to be able to establish a connection between the two devices, thereby consuming valuable time and resource of both the devices.

The problem may be worse if the service consuming device desires to consume a specific type of service, and there is a plurality of devices in the wireless network of which only one device may be offering the specific type of service. The service consuming device, in this case, may have to establish connection with each potential service providing device, one after another, until the service consuming device discovers the service providing device offering the specific desired type of service.

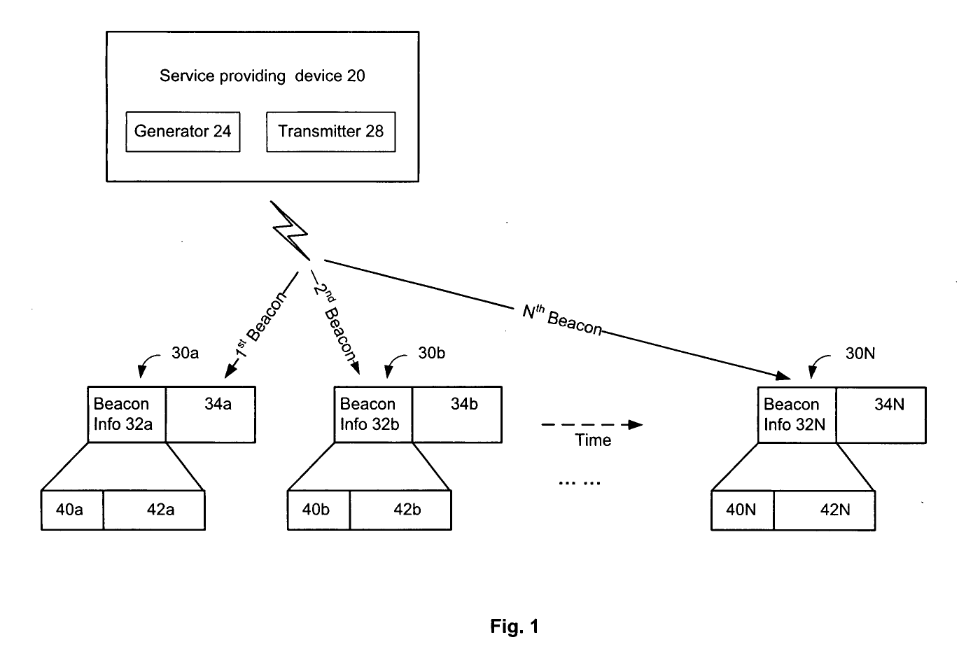

FIG. 1 illustrates a block diagram representation of a service providing device 20 transmitting a plurality of beacons in accordance with various embodiments. In various embodiments, the service providing device 20 may be configured to wirelessly communicate with other devices within a wireless network and may provide one or more services to the other devices. In various embodiments, the service providing device 20 may be, for example, a personal computer, a home entertainment system, a laptop, a printer, a wireless access point, a mobile phone, a personal digital assistant (PDA), a palmtop, a DVD player, a digital camera, a wireless modem, or any appropriate device that can offer one or more services wirelessly. In various embodiments, the service providing device 20 may be a mobile computing device. The service providing device 20 may use any appropriate standard to communicate wirelessly, e.g., IEEE 802.11 standards, including those that are Wi-Fi compatible, Bluetooth, UWB, etc.

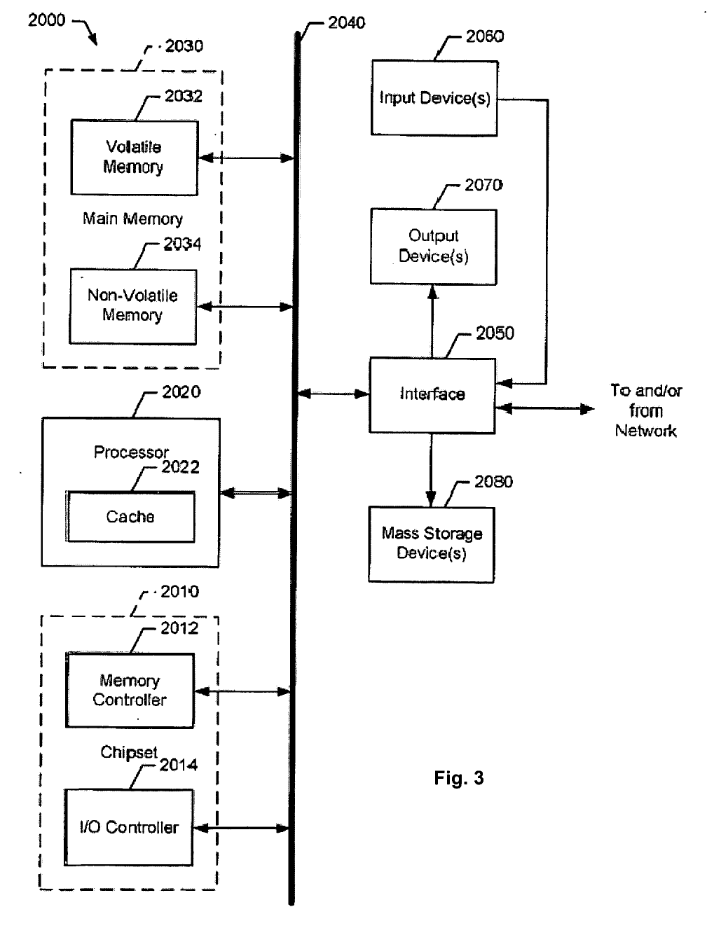

In various embodiments, the service providing device 20 may include a generator 24 to generate a plurality of beacons and a transmitter 28 to wirelessly transmit the generated beacons. In FIG. 3, only N number of beacons 30a, 30b, . . . , 30N (wherein N is an integer) are illustrated, although it would be readily apparent that the service providing device 20 is not limited to generating a fixed or a limited number of beacons and the number N is merely exemplary in nature. In various embodiments, the beacons 30a, 30b, . . . , 30N may be referred to as 1^{st}, 2^{nd}, . . . , N^{th} beacons, respectively; however, it should be apparent that such reference is made merely for illustrative and clarity purposes and the service providing device 20 may transmit numerous beacons (not shown in the figure) before transmitting the 1^{st} beacon 30a.

In various embodiments, the service providing device 20 may transmit the beacons periodically, at regular intervals. In various embodiments, there may be an interval of about 0.5 to 2 seconds between transmissions of two consecutive beacons; however, this interval may be larger or smaller based on the service providing device type, settings, etc. In various embodiments, the beacons may also be transmitted at irregular intervals. In various embodiments, the beacons may be transmitted continuously, substantially for the entire period the service producing device 20 is switched on.

In various embodiments, the beacons may be transmitted unsolicitedly, i.e., without receiving any request for such beacons from any other device. In various embodiments, the beacons may be transmitted irrespective of whether the service providing device 20 transmits/receives a request to/from another device to establish a wireless connection with the another device. Thus, the beacons may be transmitted before the service providing device 20 transmits/receives any such requests. In various embodiments, the beacons may be used to unsolicitedly advertise one or more services provided by the service providing device 20 and may include information about one or more types of services provided and optionally, an expanded description of the services provided by the service providing device 20.

In various embodiments, each beacon 30a, 30b, . . . , 30N, may include beacon information fields 32a, 32b, . . . , 32N, respectively, and optionally include other information fields 34a, 34b, . . . , 34N, respectively. In various embodiments, each of the beacon information fields 32a, 32b, . . . , 32N of each beacon 30a, 30b, . . . , 30N may include first components 40a, 40b, . . . , 40N, respectively, and second components 42a, 42b, . . . , 42N, respectively.

In various embodiments, data included in the first components 40a, 40b, 40N may be substantially similar for all the beacons 30a, 30b, . . . , 30N. Thus, the first component may be repeated in each beacon. For this reason, in various embodiments, the first component may be referred as a fixed data component.

In various embodiments, the first component, 40a, 40b, . . . , 40N, in each beacon may include an identifier identifying the service providing device 20 and/or a basic description of a service provided by the service providing device 20. In various embodiments, the first components 40a, 40b, . . . , 40N in each beacon may include a summary of the basic description of one or more services provided by the service providing device 20. In various embodiments, the first component in each beacon may include a basic unique handle associated with a provided service. For example, in various embodiments, the first component may include a service identifier that may be looked up on an Internet server, or correlated with other beacon broadcasts to obtain basic information about a provided service and/or the service providing device 20.

In various embodiments, the second components 42a, 42b, . . . , 42N may have a variable data component. That is, the information included in the second components may be different for at least some of the beacons 30a, 30b, . . . , 30N. In various embodiments, the second components of the plurality of beacons may jointly provide an expanded description of one or more services provided by the service providing device 20. For example, the second component 42a of the 1^{st} beacon may include a at least in part a first expanded description, the second component 42b of the 2^{nd} beacon may include the remaining part of the first expanded description and/or a second expanded description, and so on, such that, in combination, the 1^{st}, 2^{nd}, . . . , N^{th} expanded description provides a full expanded description of the one or more provided services. In various embodiments, the second component 42a of the 1^{st} beacon may include a first part of an expanded description, the second component 42b of the 2^{nd} beacon may a second part of the expanded description, and so on, such that, in combination, the 1^{st}, 2^{nd}, . . . , N^{th} part of the expanded description provides a full expanded description of the one or more provided services. In various embodiments, the expanded description of services may include detailed parameters describing the one or more provided services.

Thus, the second components 42a, 42b, . . . , 42N may provide a running commentary about a service, or services, spread over several beacons. In various embodiments, a nearby service consumption device (not shown in the figure) may wirelessly receive the beacons in succession and may identify, jointly from the second components of the received beacons, the expanded description of the services.

In various embodiments, the service providing device 20 may repeat the beacons in a cyclic order. For example, if the second components of the 1^{st}, 2^{nd}, . . . , N^{th} beacons fully provide the expanded description of the services, the second components of the (N+1)^{th}, (N+₂)^{th}, . . . , 2N^{th} beacons may include information similar to that of the 1^{st}, 2^{nd}, . . . , N^{th} beacons, respectively. Similarly, the second components of the (2N+1)^{th}, (2N+2)^{th}, . . . , 3N^{th} beacons may include information similar to that of the (N+1)^{th}, (N+2)^{th}, . . . , 2N^{th} beacons, respectively.

Thus, if the nearby service consumption device misses one or more of the beacons from the 1^{st}, 2^{nd}, . . . , N^{th} beacons, the service consumption device may wait for the next cycle of beacons (i.e., wait for the (N+1)^{th}, (N+2)^{th}, . . . , 2N^{th} beacons and/or wait for the (2N+1)^{th}, (2N+2)^{th}, . . . , 3N^{th} beacons).

In various embodiments, the number N, i.e., the number of beacons in one cycle may be based in part on the number of beacons necessary for fully providing the expanded description of the services. For example, if six beacons (i.e., if six of the second components of the six beacons) are necessary to fully provide the expanded description of the services, then N may at least be equal to six.

Thus, even though the data size of one beacon (or the size of the beacon info field) may be limited (in various embodiments, which may be 256 bytes), the service providing device 20 may utilize a plurality of beacons, in combination, to advertise an expanded description of one or more services provided by the service providing device 20. A service consumption device, which may consume one or more services provided by the service providing device 20, may receive the plurality of beacons, and identify, jointly from the second components of the plurality of beacons, the expanded description of the services.

In various embodiments, as the service consumption device continues receiving the beacons (e.g., 1^{st}, 2^{nd}, . . . beacons) of one cycle, the service consumption device may cumulatively discern the services being offered by the service providing device 20. That is, as the service consumption device continues receiving more and more beacons, the service consumption device may be better able to discern the services offered by the service providing device 20 from the second components of the received beacons.

In various embodiments, if the radio MAC layer supports ‘probes’, a service consumption device may also probe the service-providing device to request a more detailed description of one or more provided services. The service consumption device may do this after receiving a beacon summary, such that there is a high probability the service-providing device supports one or more services the service consumption device desires to consume. Probes are complicated by low-power modes a mobile service providing device may put itself into, as it may not be awake to listen (saving power) to a probe request. The probes may only be received at some well defined time, for example, in a small window within a beacon slot. Further, probes are also constrained by the maximum slot size in a beacon. Thus probes may not be a general purpose alternative mechanism that can be used to advertize extensive service descriptions in the same way as additive beacons may be used for forming ad-hoc wireless networks among battery operated mobile devices.

In various embodiments, if the service consumption device or its user finds one or more services offered by the service providing device 20 to be suitable, the service consumption device may transmit a request to the service providing device 20 to establish a wireless connection with the service providing device 20 to consume the one or more services offered by the service providing device 20. In various embodiments, the request to establish the wireless connection and subsequently, establishing the wireless connection, may be performed using one or more techniques well known to those skilled in the art.

In various embodiments, the previously discussed expanded description of services may include, but not limited to, a name of a service offered, an internet protocol (IP) address of the service providing device 20, a port number of the service providing device 20, a version number of the service offered, a supported protocol for accessing the service offered, an identity of the service providing device 20 optionally in the form of an XML description or compressed XML, a type of supported network connection for connecting to the service providing device 20, a list of peripheral devices attached to the service providing device 20, information associated with a sensor associated with the service providing device 20, a security setting required to access the service offered, a location required to access the service offered, a safety requirement to be eligible to access the service offered, or a storage type of the service providing device 20.

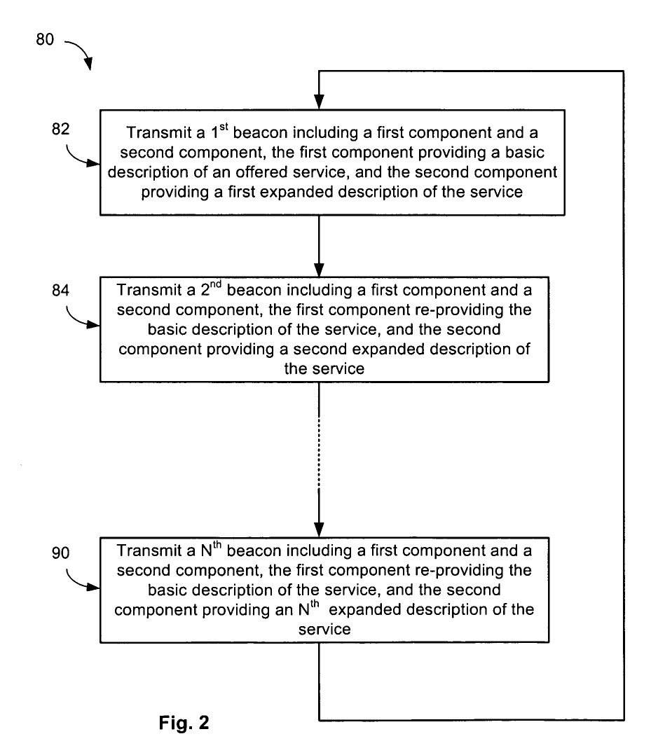

FIG. 2 illustrates an exemplary flow diagram 80 illustrating transmission of the plurality of beacons of FIG. 1 in accordance with various embodiments. Referring to FIGS. 1 and 2, at 82, the transmitter 28 transmits the 1^{st} beacon 30a, including the first component 40a and the second component 42a, the first component 40a providing a basic description of one or more services offered by the service providing device 20, and the second component 42a providing a first expanded description of the offered services. At 84, the transmitter 28 transmits the second beacon 30b including the first component 40b and the second component 42b, the first component 40b re-providing the basic description of the offered services, and the second component 40b providing the second expanded description of the offered services. The transmitter continues to transmit beacons (illustrated by the dotted lines) until it transmits, at 90, the N^{th} beacon 30N, including the first component 40N and the second component 42N, the first component 40N re-providing the basic description of the service, and the second component 42N providing the N^{th} expanded description of the services. The transmitter 28 may, subsequently, re-transmit the first beacon once again at 82 (actually, the transmitter may be re-transmitting a beacon similar to the 1^{st} beacon at 82, i.e., the (N+1)^{th} beacon; however, for the purpose of illustration, the transmitter is shown to repeatedly transmit the 1^{st}, 2^{nd}, . . . beacons in the loop).

FIG. 3 illustrates an exemplary block diagram representation of an example processor based system 2000 that may be used to practice various embodiments. The processor system 2000 illustrated in FIG. 3 includes a chipset 2010, which includes a memory controller 2012 and an input/output (I/O) controller 2014. The chipset 2010 may provide memory and I/O management functions as well as a plurality of general purpose and/or special purpose registers, timers, etc. that are accessible or used by a processor 2020. The processor 2020 may be implemented using one or more processors, WLAN components, WPAN components, WMAN components, WWAN components, and/or other suitable processing components. The processor 2020 may include a cache 2022, which may be implemented using a first-level unified cache (L1), a second-level unified cache (L2), a third-level unified cache (L3), and/or any other suitable structures to store data.

The memory controller 2012 may perform functions that enable the processor 2020 to access and communicate with a main memory 2030 including a volatile memory 2032 and a non-volatile memory 2034 via a bus 2040. The volatile memory 2032 may be implemented by synchronous dynamic random access memory (SDRAM), dynamic random access memory (DRAM), RAMBUS dynamic random access memory (RDRAM), and/or any other type of random access memory device. The non-volatile memory 2034 may be implemented using flash memory, read only memory (ROM), electrically erasable programmable read only memory (EEPROM), and/or any other desired type of memory device.

The processor system 2000 may also include an interface circuit 2050 that is coupled to the bus 2040. The interface circuit 2050 may be implemented using any type of interface standard such as an Ethernet interface, a universal serial bus (USB), a third generation input/output interface (3GIO) interface, and/or any other suitable type of interface. In various embodiments, the interface circuit 2050 may be incorporated with the earlier describe generic bootstrap teachings. In various embodiments, some of the teachings may be implemented in other components, e.g., I/O controller 2014.

One or more input devices 2060 may be connected to the interface circuit 2050. The input device(s) 2060 permit an individual to enter data and commands into the processor 2020. For example, the input device(s) 2060 may be implemented by a keyboard, a mouse, a touch-sensitive display, a track pad, a track ball, an isopoint, and/or a voice recognition system.

One or more output devices 2070 may also be connected to the interface circuit 2050. For example, the output device(s) 2070 may be implemented by display devices (e.g., a light emitting display (LED), a liquid crystal display (LCD), a cathode ray tube (CRT) display, a printer and/or speakers). The interface circuit 2050 may include, among other things, a graphics driver card.

The processor system 2000 may also include one or more mass storage devices 2080 to store software and data. Examples of such mass storage device(s) 2080 include floppy disks and drives, hard disk drives, compact disks and drives, and digital versatile disks (DVD) and drives.

The interface circuit 2050 may also include a communication device such as a modem or a network interface card to facilitate exchange of data with external computers via a network. The communication link between the processor system 2000 and the network may be any type of network connection such as an Ethernet connection, a digital subscriber line (DSL), a telephone line, a cellular telephone system, a coaxial cable, etc.

Access to the input device(s) 2060, the output device(s) 2070, the mass storage device(s) 2080 and/or the network may be controlled by the I/O controller 2014. In particular, the I/O controller 2014 may perform functions that enable the processor 2020 to communicate with the input device(s) 2060, the output device(s) 2070, the mass storage device(s) 2080 and/or the network via the bus 2040 and the interface circuit 2050.

While the components shown in FIG. 3 are depicted as separate blocks within the processor system 2000, the functions performed by some of these blocks may be integrated within a single semiconductor circuit or may be implemented using two or more separate integrated circuits. For example, although the memory controller 2012 and the I/O controller 2014 are depicted as separate blocks within the chipset 2010, the memory controller 2012 and the I/O controller 2014 may be integrated within a single semiconductor circuit.

In some embodiments, the processor system 2000 may be coupled to an antenna structure (not shown in the figure) to provide access to other devices of a network. In some embodiments, the antenna structure may include one or more directional antennas, which radiate or receive primarily in one direction (e.g., for 120 degrees), cooperatively coupled to one another to provide substantially omnidirectional coverage; or one or more omnidirectional antennas, which radiate or receive equally well in all directions. In some embodiments, the antenna structure may include one or more directional and/or omnidirectional antennas, including, e.g., a dipole antenna, a monopole antenna, a patch antenna, a loop antenna, a microstrip antenna or any other type of antennas suitable for OTA transmission/reception of RF signals.

In various embodiments, the processor system 2000 may be a desktop computer, a laptop computer, a handheld computer, a tablet computer, a mobile phone, a PDA, a palmtop, an MP3 player, a server, an Internet appliance, and/or any other type of computing device capable of supporting wireless communication with another system. In various embodiments, the processor system 2000 may be designed to support mobile computing. In various embodiments, the processor system 2000 may wirelessly provide one or more services to one or more service consuming devices.

In various embodiments, the processor system 2000 may be capable of functioning as the service providing device 20 of FIG. 1. The processor system 2000 may include a beacon generator (similar to the generator 24 of FIG. 1) coupled to the bus 2040, to generate the plurality of beacons previously discussed. In various embodiments, the processor 2020 may also operate as the beacon generator. In various embodiments, the processor system 2000 may also include a beacon transmitter (similar to the transmitter 28 of FIG. 1) to transmit the generated beacons. In various embodiments, the beacon transmitter may utilize the previously discussed antenna structure (not shown in the figure) of the processor system 2000 to wirelessly transmit the generated beacons. In various embodiments, the beacon transmitter may utilize an ultra-wide band (UWB) radio to transmit the plurality of beacons. In various embodiments, the beacon generator and the beacon transmitter may be configured to perform MAC layer operations of the processor system 2000. In various embodiments, the processor system 2000 may transmit the beacons unsolicitedly to advertise one or more services provided by the processor system 2000, before receiving a request from another device requesting to establish connection with the processor system 2000 to consume one or more services offered by the processor system 2000.

Although certain example methods, apparatus, and articles of manufacture have been described herein, the scope of coverage of this disclosure is not limited thereto. On the contrary, this disclosure covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

What is claimed is:

1. A method comprising:
transmitting wirelessly, by a service providing device, a first beacon including first one or more components; and
transmitting wirelessly, by the service providing device, a second beacon including second one or more components, the first beacon and the second beacon providing information that jointly contributes to enabling a service consumption device to cumulatively discern a service being offered by the service providing device.

2. The method of claim 1, wherein said transmitting the first and the second beacon comprises:
transmitting the first beacon, the first one or more components including a first component and a second component, the first component providing a basic description of the service offered by the service providing device, and the second component providing a first expanded description of the service; and
transmitting the second beacon, the second one or more components including another first component and another second component, the another first component re-providing the basic description of the service, and the another second component providing a second expanded description of the service.

3. The method of claim 2, further comprising transmitting wirelessly, by the service providing device, a third beacon including another first component re-providing the basic description of the service, and another second component providing a third expanded description of the service, adding to the first and second expanded descriptions to jointly contribute to enabling the service consumption device to cumulatively discern the service being offered.

4. The method of claim 1, wherein said transmitting of the first beacon and the second beacon comprises:
transmitting unsolicitedly, by the service providing device, the first beacon and the second beacon.

5. The method of claim 1, wherein said transmitting of the first beacon and the second beacon comprises:
transmitting, by the service providing device, the first beacon and the second beacon before accepting any request to establish a connection with said service consumption device.

6. The method of claim 2, wherein said transmitting of the second beacon comprises:
transmitting the second beacon with the another second component having at least complete or part of one of a name of the service offered, an internet protocol (IP) address of the service providing device, a port number of the service providing device, a version number of the service offered, a supported protocol for accessing the service offered, an identity of the service providing device, a type of supported network connection for connecting to the service providing device, or a compressed extensible markup language (XML) description of the service.

7. The method of claim 1, wherein said transmitting of the first beacon and the second beacon comprises:
transmitting, by the service providing device, the first beacon and the second beacon using an ultra-wide band (UWB) radio.

8. The method of claim 1, wherein said transmitting of the first beacon and the second beacon comprises:
transmitting, by the service providing device, the first beacon with the first component having a unique handle associated with the offered service.

9. A method comprising:
receiving wirelessly, by a service consumption device, a first beacon from a service providing device, including a first component and a second component; and
receiving wirelessly, by the service consumption device, a second beacon from the service providing device, including another first component and another second component;
identifying, by the service consumption device, jointly from the first and second beacons, one or more services offered by the service providing device.

10. The method of claim 9, wherein said receiving the first and second beacons further comprises:
receiving the first beacon, including the first component providing a summarized description of the one or more services offered by the service providing device, and the second component providing a first part of an expanded description of the one or more services offered; and
receiving the second beacon, including another first component re-providing the summarized description of the one or more services offered, and another second component providing a second part of the expanded description of the one or more services offered.

11. The method of claim 10, further comprising:
receiving wirelessly, by the service consumption device, a third beacon from the service providing device, including another first component re-providing the summarized description of the one or more services offered, and another second component providing a third part of the expanded description of the one or more services offered; and
identifying, by the service consumption device, jointly from the summarized description and the first, second, and third part of the expanded description, the one or more services offered.

12. The method of claim 9, wherein said receiving of the first and the second beacon comprises:
receiving, by the service consumption device, the first and the second beacon from the service providing device prior to transmitting a request to establish a connection between the service consumption device and the service providing device.

13. The method of claim 9, further comprising:
transmitting wirelessly, by the service consumption device, in response to identifying the one or more services offered, a request to connect to the service providing device to consume at least a selected one of the one or more services offered.

14. An apparatus comprising:
a beacon generator configured to generate a first beacon including a first component providing a basic description of one or more services offered by the apparatus, and a second component providing a first part of an expanded description of the one or more services offered, the beacon generator further configured to generate a second beacon including another first component re-providing the basic description of the one or more services, and another second component providing a second part of the expanded description of the one or more services offered; and
a beacon transmitter configured to unsolicitedly transmit the first and the second beacon over a wireless medium;
wherein the basic and the expanded descriptions, in combination, provide a description of the one or more services provided by the apparatus.

15. The apparatus of claim 14, wherein the apparatus comprises a plurality of components configured to perform Media Access Control (MAC) layer operations of wireless communication, the plurality of components comprising the beacon generator and the beacon transmitter.

16. The apparatus of claim 14, wherein the one or more services are designed to support mobile computing on mobile computing devices.

17. The apparatus of claim 14, wherein at least one of the first and second part of the expanded description includes a name of at least one of the one or more services offered, a list of peripheral devices attached to the apparatus, information associated with a sensor associated with the apparatus, a security setting required to access the one or more services offered, a location required to access the one or more services offered, a safety requirement to be eligible to access the one or more services offered, or a storage type of the apparatus.
